(19) United States
(12) Patent Application Publication
(10) Pub. No.: US 2024/0117749 A1
(43) Pub. Date: Apr. 11, 2024

(54) Method of manufacturing labyrinth sealing device for turbine using 3D printing

(71) Applicants: Hyun Ki KANG, Busan (KR); Taek Ho CHUNG, Busan (KR); Sam Sub BYUN, Busan (KR)

(72) Inventors: Hyun Ki KANG, Busan (KR); Taek Ho CHUNG, Busan (KR); Sam Sub BYUN, Busan (KR)

(21) Appl. No.: 18/105,405

(22) Filed: Feb. 3, 2023

(30) Foreign Application Priority Data
Oct. 7, 2022 (KR) 10-2022-0129128

(51) Int. Cl. F01D 11/02

(52) U.S. Cl. CPC F01D 11/02; B33Y 80/00; F05D 2230/21; F05D 2230/237; F05D 2300/171

(57) ABSTRACT

A method of manufacturing a labyrinth sealing device mounted between a diaphragm and a turbine rotor of a turbine to induce smooth rotation of the turbine rotor and prevent a leakage of gas by minimizing friction is presented. A labyrinth sealing device includes a ring-shaped body and a labyrinth part protruding from one surface of the ring-shaped body. The ring-shaped body is manufactured by centrifugal casting or ring mill, and the labyrinth part is manufactured by 3D printing.

### BACKGROUND OF THE INVENTION

### Field of the Invention

The present invention relates to a method of manufacturing a labyrinth sealing device for a turbine and, more specifically, to a method of manufacturing a labyrinth sealing device, which is mounted between a diaphragm and a turbine rotor of a turbine using three-dimensional printing.

### Background Art

A turbine is a rotary machine that extracts energy from a fluid flow and converts the energy into kinetic energy. There are various types of turbines, for example, a steam turbine using steam, a gas turbine using combustion gas, and the like according to operating principles and structures. [Naver Knowledge Encyclopedia]

In general, in order to produce electric power by using a turbine for power generation, high-temperature and high-pressure steam generated from a boiler flows into a turbine casing through a turbine stop valve and a control valve, and the steam introduced into the casing rotates a moving blade assembled to a turbine rotor via a diaphragm, so that a power generator is rotated by the turbine rotor to obtain electric power.

In this instance, the diaphragm induces the introduced steam or gas to become a steam flow having an optimal steam direction and rotates the moving blade assembled to the turbine rotor.

Because a leakage of steam generated in a sealing part between a rotor such as a turbine rotor and a stator such as a diaphragm surrounding the turbine rotor in the turbine is a main factor which lowers efficiency of the turbine and increases fuel costs, a design technique of a sealing device for reducing a steam leakage is very important.

Here, a sealing device made of a stainless steel material used for a high-temperature and high-pressure turbine, such as a steam turbine or a gas turbine, plays a significant role to increase energy production efficiency of a power generator by preventing the leakage of steam or gas, and to prevent vibration of the rotor due to fluid.

Accordingly, in order to induce smooth rotation of the turbine rotor and prevent the leakage of gas by minimizing friction between the rotor and the stator when the rotor such as the turbine rotor rotates in the stator such as the diaphragm, a non-contact type sealing device is mounted and used between the turbine rotor and the diaphragm.

As a representative non-contact sealing device, there is a labyrinth sealing device.

The labyrinth sealing device includes a ring-shaped body and teeth protruding from one surface of the body. A vortex is formed between the labyrinth and the turbine rotor, thereby maintaining airtightness and facilitating the rotation of the turbine rotor to prevent the turbine rotor from getting in contact with the teeth protruding complicatedly.

With respect to the labyrinth sealing device, please refer to Korean Patent No. 10-1442739 (filed on Apr. 8, 2014 and granted on Sep. 15, 2014) and Korean Patent No. 10-1449473 (filed on May 29, 2014 and granted on Oct. 2, 2014) by the same applicant of the present invention.

However, the conventional labyrinth sealing devices have several disadvantages in that manufacturing costs increase due to a severe waste of materials during a process of carving the teeth of the labyrinth with a machining tool after the ring-shaped body is formed by centrifugal casting or ring mill, and in that a manufacturing period is extended and productivity is not good since it is difficult to form the teeth.

### PATENT DOCUMENTS

### Patent Literature

Patent Document 1: Korean Patent No. 10-0876603 (granted on Dec. 23, 2008)
Patent Document 2: Korean Patent No. 10-14442739 (granted on Sep. 15, 2014)
Patent Document 3: Korean Patent No. 10-1449473 (granted on Oct. 2, 2014)
Patent Document 4: Korean Patent No. 10-1546385 (granted on Aug. 17, 2015)
Patent Document 5: Korean Patent No. 10-1950924 (granted on Feb. 15, 2019)
Patent Document 6: Korean Patent No. 10-2293186 (granted on Aug. 18, 2021)

### SUMMARY OF THE INVENTION

Accordingly, the present invention has been made to solve the above-mentioned problems occurring in the prior arts, and it is an object of the present invention to provide a method of manufacturing a labyrinth sealing device of a turbine, in which a ring-shaped body is manufactured and teeth protruding from the ring-shaped body is manufactured by using three-dimensional printing, thereby improving productivity by reducing material costs and machining costs.

To accomplish the above object, according to the present invention, there is provided a method of manufacturing a labyrinth sealing device mounted between a diaphragm and a turbine rotor of a turbine in order to induce smooth rotation of the turbine rotor and prevent a leakage of gas by minimizing friction between a rotor, such as the turbine rotor, and a stator, such as the diaphragm, when the rotor rotates in the stator, wherein the labyrinth sealing device includes a ring-shaped body and a labyrinth part protruding from one surface of the ring-shaped body, the ring-shaped body is manufactured by centrifugal casting or ring mill, and the labyrinth part is manufactured by 3D printing.

As described above, the method of manufacturing a labyrinth sealing device of a turbine according to the present invention can improve productivity by reducing material costs and machining costs by manufacturing the labyrinth part protruding from the ring-shaped body using three-dimensional printing after manufacturing the ring-shaped body. Moreover, the method of manufacturing a labyrinth sealing device can manufacture the labyrinth part in various shapes according to usage environments since the labyrinth part is manufactured by three-dimensional printing.

### BRIEF DESCRIPTION OF THE DRAWINGS

FIG. 1 is a sectional view illustrating a state in which a sealing device is mounted in a turbine.

FIG. 2 is an enlarged view of a portion of FIG. 1.

FIG. 3 is a sectional view of a labyrinth sealing device according to a method of manufacturing a labyrinth sealing device of a turbine using three-dimensional printing according to an embodiment of the present invention.

FIG. 4 is a partially enlarged sectional view illustrating a state in which the labyrinth sealing device according to the method of manufacturing a labyrinth sealing device using three-dimensional printing is mounted in a turbine.

FIG. 5 is a sectional view of a labyrinth sealing device according to a method of manufacturing a labyrinth sealing device of a turbine using three-dimensional printing according to another embodiment of the present invention.

### DETAILED DESCRIPTION OF THE PREFERRED EMBODIMENT

The present invention relates to a method of manufacturing a labyrinth sealing device of a turbine using three-dimensional printing (hereinafter, called a ‘3D printing’). The method of manufacturing a labyrinth sealing device according to the present invention is characterized in that a labyrinth sealing device is mounted between a diaphragm 200 and a turbine rotor 100 of a turbine in order to induce smooth rotation of the turbine rotor 100 and prevent a leakage of gas by minimizing friction between a rotor, such as the turbine rotor 100, and a stator, such as the diaphragm 200, when the rotor rotates in the stator, wherein the labyrinth sealing device 300 includes a ring-shaped body 310 and a labyrinth part 320 protruding from one surface of the ring-shaped body 310, the ring-shaped body 310 is manufactured by centrifugal casting or ring mill, and the labyrinth part 320 is manufactured by 3D printing.

The ring-shaped body 310 and the labyrinth part 320 can be firmly coupled with each other by being bonded by any one among laser cladding and brazing.

Furthermore, the ring-shaped body 310 is made of a stainless steel material, and the labyrinth part 320 is made of a material different from the stainless steel material.

Additionally, the labyrinth part 320 includes a plate-shaped base 321, and a teeth part 322 protruding from one surface of the base 321, and the base 321 of the labyrinth part 320 gets in contact with the ring-shaped body 310. Thereafter, the labyrinth part 320 and the ring-shaped body 310 are bonded by laser cladding or brazing.

The base 321 of the labyrinth part 320 is made of the same material as the ring-shaped body 310, and the teeth part 322 may be made of a material different from that of the base 321.

Hereinafter, the method of manufacturing a labyrinth sealing device using 3D printing according to the present invention will be described in detail with reference to the accompanying drawings.

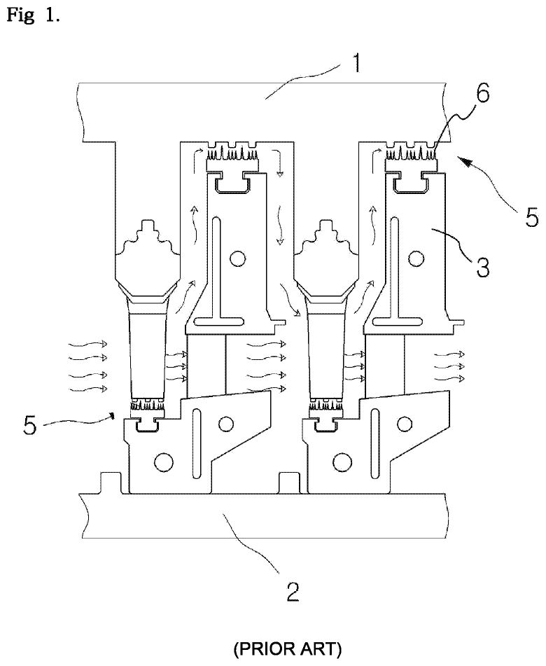

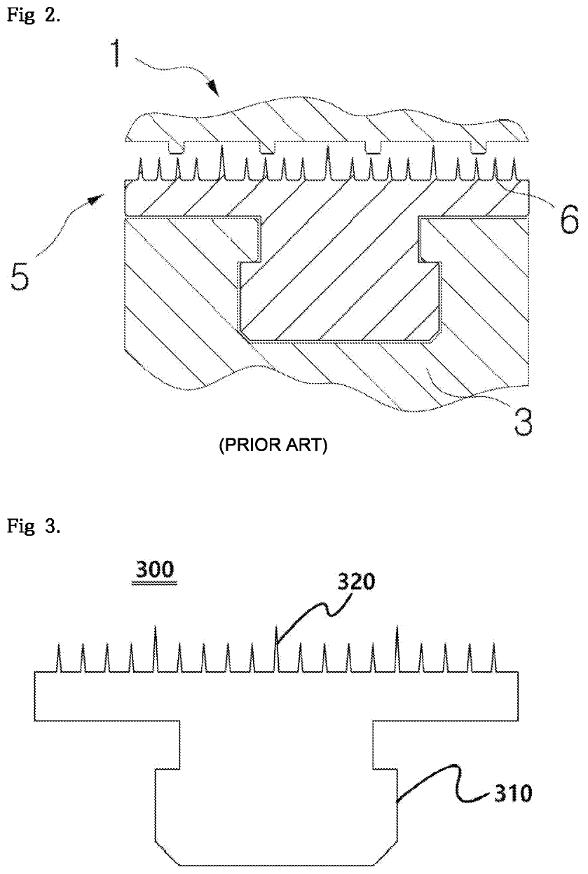

FIG. 1 is a sectional view illustrating a state in which a sealing device is mounted in a turbine, and FIG. 2 is an enlarged view of a portion of FIG. 1.

As illustrated in FIGS. 1 and 2, a conventional labyrinth type sealing device 5 is installed between an outer ring and an inner ring of a diaphragm 3 mounted in a casing.

Here, the labyrinth type sealing device 5 has been widely used as a non-contact type annular sealing device of a turbine, and reduces a leakage flow rate by generating a throttling process in a fluid flowing in the turbine using sharp teeth 6.

That is, the teeth 6 are arranged in order in a flow direction of the fluid, thereby reducing a leakage flow rate of the fluid through a pressure drop effect generated while the fluid repeats expansion and contraction.

For more detailed contents, please refer to the Korean patent gazette of Korean Patent No. 10-1442739 (filed on Apr. 8, 2014 and granted on Sep. 15, 2014 by the same applicant of the present invention).

However, the conventional labyrinth type sealing device having the teeth 6 has several disadvantages in that materials are wasted severely while carving the labyrinth with a machining tool after the ring-shaped body is formed by centrifugal casting, and in that a manufacturing period is extended and productivity is not good since it is difficult to form the teeth.

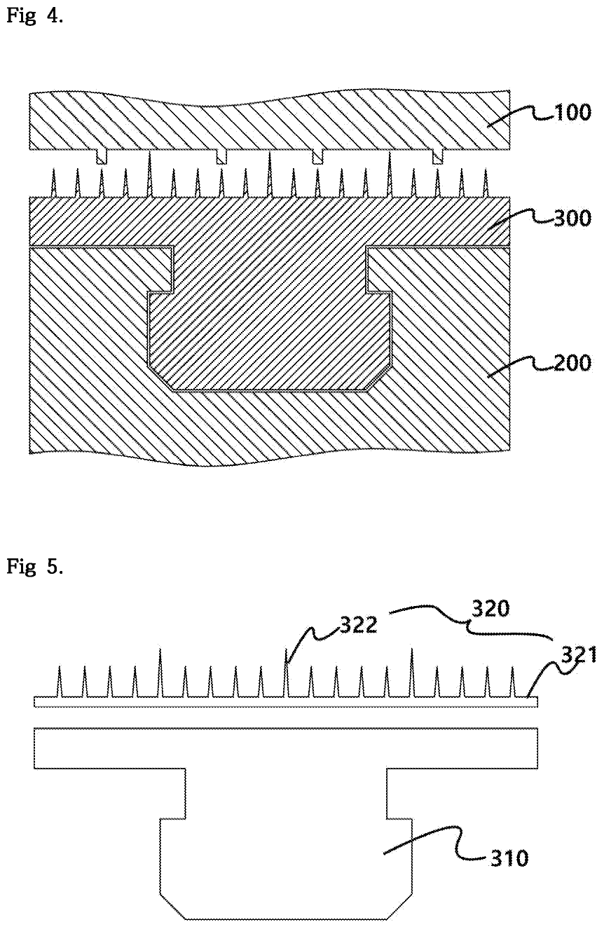

FIG. 3 is a sectional view of a labyrinth sealing device according to a method of manufacturing a labyrinth sealing device of a turbine using three-dimensional printing according to an embodiment of the present invention, and FIG. 4 is a partially enlarged sectional view illustrating a state in which the labyrinth sealing device according to the method of manufacturing a labyrinth sealing device using three-dimensional printing is mounted in a turbine.

As illustrated in FIGS. 3 to 4, the present invention relates to a method of manufacturing a labyrinth sealing device 300 using 3D printing. The labyrinth sealing device 300 is mounted between a diaphragm 200 and a turbine rotor 100 of a turbine in order to induce smooth rotation of the turbine rotor 100 and prevent a leakage of gas by minimizing friction between a rotor such as the turbine rotor 100 and a stator such as the diaphragm 200 when the rotor rotates in the stator.

In general, the labyrinth sealing device 300 includes a ring-shaped body 310, and a labyrinth part 320 protruding from one surface of the ring-shaped body 310.

In the labyrinth sealing device 300 of the present invention, the ring-shaped body 310 is manufactured by centrifugal casting or ring mill, and the labyrinth part 320 is manufactured by 3D printing.

In this instance, the ring-shaped body 310 and the labyrinth part 320 may have a firm coupling relationship by being bonded by any one among laser cladding and brazing.

The ring-shaped body 310 and the labyrinth part 320 may use different bonding methods according to circumstances.

Especially, the ring-shaped body 310 according to the present invention may be made of a stainless steel material, and the labyrinth part 320 may be made of a material different from the stainless steel material.

Meanwhile, in the present invention, since the labyrinth part 320 is manufactured by the following method, the labyrinth part 320 can be manufactured more conveniently by 3D printing, and the manufactured labyrinth part 320 can be firmly bonded to the ring-shaped body 310.

The shape of the ring-shaped body 310 is not limited to the shape illustrated in FIG. 3, and may have various shapes according to the shape of the diaphragm 200 corresponding to the body 310.

FIG. 5 is a sectional view of a labyrinth sealing device according to a method of manufacturing a labyrinth sealing device of a turbine using three-dimensional printing according to another embodiment of the present invention.

As illustrated in FIG. 5, the labyrinth part 320 according to another embodiment of the present invention includes a plate-shaped base 321 and a teeth part 322 protruding from one surface of the base 321.

The shape of the teeth part 322 may be manufactured in a brush shape or may be transformed into various shapes, such as a plurality of thin plate shapes.

The base 321 of the labyrinth part 320 gets in contact with the ring-shaped body 310, and then, is bonded in a bonding manner such as brazing or laser cladding, so that the labyrinth part 320 and the ring-shaped body 310 can have a firm bonding relationship.

Particularly, since the base 321 of the labyrinth part 320 of the present invention is made of the same material as the ring-shaped body 310, the labyrinth part 320 and the ring-shaped body 310 of the present invention can have the firm bonding relationship.

The teeth part 322 may be made of one selected from different materials from the base 321 depending on the material or shape of the turbine rotor 100 or performance of the turbine rotor 100.

Meanwhile, in order to have a stronger bonding relationship between the labyrinth part 320 and the body 310, a protrusion part (not shown) is formed on any one among contact surfaces that the base 321 and the body 310 get in contact with each other, and a groove part (not shown) corresponding to the protrusion part is formed on the other surface, so that the labyrinth part 320 and the body 310 can be assembled to each other like an assembly-type block and can be bonded by brazing.

The body 310, the base 321 and the teeth part 322 of the labyrinth part 320 according to the present invention can be modified or manufactured in various shapes within the scope of the present invention.

As described above, the method of manufacturing a labyrinth sealing device of a turbine according to the present invention can improve productivity by reducing material costs and machining costs by manufacturing the labyrinth part protruding from the ring-shaped body using three-dimensional printing after manufacturing the ring-shaped body. In addition, the method of manufacturing a labyrinth sealing device can manufacture the labyrinth part in various shapes according to usage environments since the labyrinth part is manufactured by three-dimensional printing.

1. A method of manufacturing a labyrinth sealing device mounted between a diaphragm and a turbine rotor of a turbine in order to induce smooth rotation of the turbine rotor and prevent a leakage of gas by minimizing friction between a rotor,
wherein the labyrinth sealing device includes a ring-shaped body and a labyrinth part protruding from one surface of the ring-shaped body, the ring-shaped body is manufactured by centrifugal casting or ring mill, and the labyrinth part is manufactured by 3D printing,
wherein the ring-shaped body and the labyrinth part are made of a stainless steel material, firmly coupled with each other by being bonded by any one among laser cladding and brazing, and the labyrinth part is made of a material different from the stainless-steel material,
wherein the labyrinth part includes a plate-shaped base, and a teeth part protruding from one surface of the base, the base of the labyrinth part gets in contact with the ring-shaped body, and then, the labyrinth part and the ring-shaped body are bonded by a laser cladding or a brazing, the base of the labyrinth part is made of the same material as the ring-shaped body, and the teeth part is made of a material different from that of the base,
wherein in order to have a stronger bonding relationship between the labyrinth part and the body, a protrusion part is formed on any one among contact surfaces that the base and the body get in contact with each other, and a groove part corresponding to the protrusion part is formed on the other surface, so that the labyrinth part and the body can be assembled to each other like an assembly-type block and can be bonded by brazing.

2. (canceled)

3. (canceled)

4. (canceled)

5. (canceled)
